(19) United States
(12) Patent Application Publication
(10) Pub. No.: US 2014/0136749 A1
(43) Pub. Date: May 15, 2014

(54) CABLE DOCK ASSEMBLY AND METHOD OF MANUFACTURING THE SAME

(71) Applicant: Belkin International, Inc., Playa Vista, CA (US)

(72) Inventors: Timothy North, Diamond Bar, CA (US); Mauricio Chacon, Fountain Valley, CA (US); Sydney Wen, Playa Del Rey, CA (US); Ken Mori, Los Angeles, CA (US)

(73) Assignee: Belkin International, Inc., Playa Vista, CA (US)

(21) Appl. No.: 14/077,422

(22) Filed: Nov. 12, 2013

Related U.S. Application Data
(60) Provisional application No. 61/725,326, filed on Nov. 12, 2012.

(51) Int. Cl. G06F 13/40

(52) U.S. Cl. CPC G06F 13/4022
USPC 710/313

(57) ABSTRACT

A cable dock assembly can include a first sub-assembly including a power adapter configured to attach to a power source, a second sub-assembly including a first video display plug configured to attach to a first video display, a third sub-assembly including a universal serial bus plug configured to attach to a computing device placed on a surface, a first electrical cable attached at the first sub-assembly and the second sub-assembly, a second electrical cable attached at the second sub-assembly and the third sub-assembly, and one or more controller chips. The one or more controller chips can be fully contained within at least one of the first, second, or third sub-assemblies. Other related assemblies and methods are also provided.

### CROSS-REFERENCE TO RELATED APPLICATIONS

This application claims the benefit of U.S. Provisional Application No. 61/725,326, filed Nov. 12, 2012. U.S. Provisional Application No. 61/725,326 is incorporated herein by reference in its entirety.

### TECHNICAL FIELD

This disclosure relates generally to cables for use with computing devices and other electronic devices, and relates more particularly to docking systems for charging or otherwise transmitting electrical signals among such devices.

### BACKGROUND

Portable electronic devices, such as laptop computers, are commonly used for commercial and personal purposes. These devices often include internal batteries that must be recharged from time to time. Although these devices often include a video display, a smaller keyboard, and/or a pointing device (such as a touch pad), a docking station is commonly used when a laptop computer is used at a desk, as the docking station can allow the user to interact with the laptop computer using one or more larger video displays, a standard keyboard, and/or a standard mouse, among other peripherals. A docking station also can provide power for the computing device and/or charge the batteries of the computing device. Users often want to be able to easily attach and remove a laptop computer from the docking station. Moreover, user often do not want electronic components to take up valuable desk space.

### BRIEF DESCRIPTION OF THE DRAWINGS

To facilitate further description of the embodiments, the following drawings are provided in which:

FIG. 1 illustrates a perspective view of a cable dock assembly, according to an embodiment;

FIG. 2 illustrates a schematic view of control circuitry for an embodiment of a cable dock assembly, according to the embodiment of FIG. 1;

FIG. 3 illustrates a schematic view of control circuitry for an embodiment of a cable dock assembly, according to another embodiment;

FIG. 4 illustrates a cross-sectional view of a second electrical cable in a cable dock assembly, according to the embodiment of FIG. 1;

FIG. 5 illustrates a cross-sectional view of a second electrical cable in a cable dock assembly, according to another embodiment;

FIG. 6 illustrates a cross-sectional view of a first electrical cable in a cable dock assembly, according to the embodiment of FIG. 1;

FIG. 7 illustrates a cross-sectional view of a housing-to-housing electrical cable in a cable dock assembly, according to the embodiment of FIG. 1;

FIG. 8 illustrates a perspective view of the cable dock assembly of FIG. 1 and a video attachment cable, according to an embodiment;

FIG. 9 illustrates a perspective view of a cable dock assembly, according to another embodiment;

FIG. 10 illustrates a schematic view of control circuitry for an embodiment of a cable dock assembly, according to the embodiment of FIG. 9;

FIG. 11 illustrates a schematic view of control circuitry for an embodiment of a cable dock assembly, according to another embodiment;

FIG. 12 illustrates a perspective view of a cable dock assembly, according to another embodiment; and

FIG. 13 illustrates a flow chart for an embodiment of a method of manufacturing a cable dock assembly, according to the embodiments of FIG. 1.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable. “Mechanical coupling” and the like should be broadly understood and include mechanical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DESCRIPTION OF EXAMPLES OF EMBODIMENTS

Some embodiments include a cable dock assembly. The cable dock assembly includes a first sub-assembly including a power adapter configured to removably or non-removably attach to a power source. The cable dock assembly also include a second sub-assembly include a first video display plug configured to removably attach to a first video display. The cable dock assembly further includes a third sub-assembly include a universal serial bus plug configured to removably attach to a computing device placed on a surface. The cable dock assembly also includes a first electrical cable include a first end attached at the first sub-assembly and a second end attached at the second sub-assembly. The cable dock assembly further includes a second electrical cable include a first end attached at the second sub-assembly and a second end attached at the third sub-assembly. The cable dock assembly also includes one or more controller chips. The one or more controller chips are fully contained within at least one of the first, second, or third sub-assemblies. The cable dock assembly is configured such that, when the first sub-assembly is attached to the power source, the second sub-assembly is attached to the video display, and the third sub-assembly is attached to the computing device, the first, second, and third sub-assemblies are each devoid of touching the surface.

Various embodiments include a method of manufacturing a cable dock assembly. The method includes providing a first sub-assembly including a power adapter configured to removably or non-removably attach to a power source. The method also includes providing a second sub-assembly including a first video display plug configured to removably attach to a first video display. The method further includes providing a third sub-assembly including a universal serial bus plug configured to removably attach to a computing device placed on a surface. The method also includes providing a first electrical cable including a first end and a second end. The method further includes attaching the first end of the first electrical cable to the first sub-assembly and the second end of the first electrical cable to the second sub-assembly. The method also includes providing a second electrical cable including a first end and a second end. The method further includes attaching the first end of the second electrical cable to the second sub-assembly and the second end of the second electrical cable to the third sub-assembly. The method also includes providing one or more controller chips. The one or more controller chips are fully contained within at least one of the first, second, or third sub-assemblies. The cable dock assembly is configured such that, when the first sub-assembly is attached to the power source, the second sub-assembly is attached to the video display, and the third sub-assembly is attached to the computing device, the first, second, and third sub-assemblies are each devoid of touching the surface.

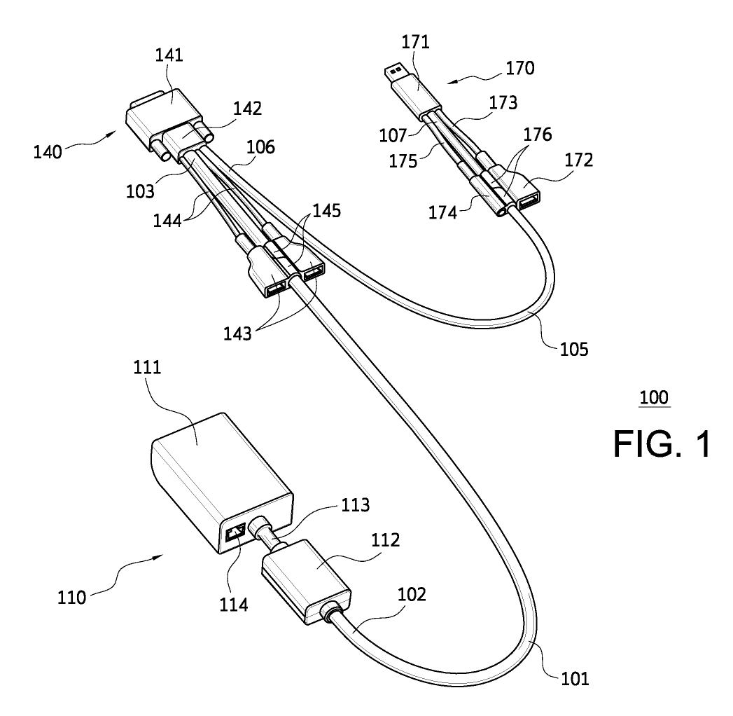

Turning to the drawings, FIG. 1 illustrates a perspective view of a cable dock assembly 100. Cable dock assembly 100 is merely exemplary and embodiments of the cable dock assembly are not limited to the embodiments presented herein. The cable dock assembly can be employed in many different embodiments or examples not specifically depicted or described herein. In many embodiments, cable dock assembly 100 can include a first sub-assembly 110, a second sub-assembly 140, and/or a third sub-assembly 170. Each of first sub-assembly 110, second sub-assembly 140, and/or third sub-assembly 170 can house circuitry, controller chips, plugs, and/or receptacles. In a number of embodiments, cable dock assembly 100 can include a first electrical cable 101 and/or a second electrical cable 105. First electrical cable 101 can include a first end 102 and/or a second end 103. First end 102 can be attached at first sub-assembly 110 and second end 103 can be attached at second sub-assembly 140. Second electrical cable 105 can include a first end 106 and/or a second end 107. First end 106 can be attached at second sub-assembly 140 and second end 107 can be attached at third sub-assembly 170.

In various embodiments, first sub-assembly 110 can include a first housing 111, a second housing 112, and/or a housing-to-housing electrical cable 113. In other embodiments, first sub-assembly 110 can include a unitary housing that includes the circuitry of first housing 111 and second housing 112. In many embodiments, housing-to-housing electrical cable 113 can connect first housing 111 to second housing 112. In a number of embodiments, first housing 111 can include a power adapter (not shown). In many embodiments, first housing 111 can include an alternating current (AC) connector (not shown) configured to connect to an AC wall power receptacle, and the power adapter can convert the AC power to direct current (DC) power. In certain other embodiments, first housing 111 can include a DC connector (e.g., a cigarette lighter adapter) configured to connect to a DC power source. In yet other embodiments, first housing 111 can be permanently attached to an AC or DC power source.

In certain embodiments, first housing 111 can include a network receptacle 114. Network receptacle 114 can include an RJ-45 Ethernet receptacle configured to connect to an Ethernet input having an 8P8C modular RJ45 connector. Network receptacle 114 can facilitate connection of a computing device through cable dock assembly 100 to a local area network (LAN) or another network. First housing 111 can include a status indicator (not shown) configured to indicate whether the adapter is powered on or off. First housing 111 and/or second housing can include additional circuitry, as described below.

In some embodiments, second sub-assembly 140 can include a first video display plug 141 and/or a strain relief 142. First video display plug 141 can be configured to removably attach to a first video display, and can facilitate connection of a computing device through cable dock assembly 100 to the first video display. For example, first video display plug 141 can include a Digital Visual Interface (DVI) digital and analog (DVI-I) male connector, as shown in FIG. 1. In various other embodiments, first video display plug 141 can include a DVI digital (DVI-D) connector, a DVI analog (DVI-A) connector, a Video Graphics Array (VGA) connector, a High-Definition Multimedia Interface (HDMI) connector, a DisplayPort (DP) connector, a Thunderbolt™ connector, or another suitable connector for a video display interface. In some embodiments, first video display plug 141 can include an adapter and/or controller (not shown) configured to convert DVI-I to VGA, DVI-I to HDMI, DP to HDMI, DVI-I to DP, or another suitable video display interface conversion. For example, in some embodiments, a DP501 DP Transmitter, sold by Parade Technologies, Inc. of Santa Clara, Calif., can be used to convert DVI-I or HDMI to DP.

In a number of embodiments, strain relief 142 can connect first video display plug 141 to second end 103 of first electrical cable 101 and/or first end 106 of second electrical cable 105, and can allow first electrical cable 101 and/or second electrical cable 105 to bend proximate to first video display plug 141 without cracking or breaking away from first video display plug 141. Strain relief 142 can include additional circuitry, as described below.

In some embodiments, cable dock assembly 100 can include one or more first universal serial bus receptacles 143. In many embodiments, first universal serial bus receptacles 143 can be Type A Universal Serial Bus (USB) receptacles. In various embodiments, first universal serial bus receptacles 143 can support USB 2.0, USB 3.0, USB 3.1, and/or another suitable communication protocol. First universal serial bus receptacles 143 can facilitate connection of a computing device through cable dock assembly 100 to one or more peripheral devices, such as a keyboard, a pointing device (such as a mouse), and/or other suitable peripheral devices.

In a number of embodiments, cable dock assembly 100 can include one or more first pigtail cables 144. In various embodiments, each of first pigtail cables 144 can connect a different one of first universal serial bus receptacles 143 to second sub-assembly 140. In many embodiments, each of first pigtail cables 144 can attach to second sub-assembly 140 at strain relief 142, which can allow first pigtail cables 144 to bend without breaking away from second sub-assembly 140. In a number of embodiments, each of first pigtail cables 144 can have a length of less than 4 inches (in.). In other embodiments, each of first pigtail cables 144 can have a length of less than 6 in. In many embodiments, first pigtail cables 144 can have a cross-sectional diameter less than the cross-sectional diameter of either first electrical cable 101 or second electrical cable 105.

In various embodiments, cable dock assembly 100 can include connective elements 145. In certain embodiments, each of first universal serial bus receptacles 143 can include one of connective elements 145. Connective elements 145 can be configured to removably connect to the outside of first electrical cable 101 and/or second electrical cable 105. For example, connective elements 145 can include rounded snaps configured to partially or fully surround first electrical cable 101 or second electrical cable 105. In some embodiments, each of connective elements 145 can be configured to connect to first electrical cable 101 or second electrical cable 105 next to another of connective elements 145. For example, in certain embodiments cable dock assembly 100 can include two first universal serial bus receptacles 143 connected to first pigtail cables 144 having approximately the same length, and the two first universal serial bus receptacles 143 can each include one of connective elements 145 configured to removably attach to first electrical cable 101. Specifically, one of connective elements 145 can be located on one of first universal serial bus receptacles 143 closer to the receptacle insertion portion and the other of connective elements 145 can be located on the other one of first universal serial bus receptacles 143 closer to the portion connected to first pigtail cables 144, as shown in FIG. 1.

In some embodiments, third sub-assembly 170 can include a universal serial bus plug 171. Universal serial bus plug 171 can be configured to removably attach to a computing device, such as a computing device placed on a table, a desk, or another surface. In some embodiments, the computing device can be a laptop computer, a desktop computer, a tablet computer, a smart phone, or another suitable computing device. In various embodiments, universal serial bus plug 171 can be a Type A USB plug. In other embodiments, universal serial bus plug 171 can be a Micro-B USB plug, or another suitable plug type for connecting to a computing device, such as, for example, the Lightning connector, developed and sold by Apple, Inc. of Cupertino, Calif. In many embodiments, universal serial bus plug 171 can support USB 2.0, USB 3.0, USB 3.1, and/or another suitable communication protocol, such as, for example, the Lightning bus protocol, created by Apple, Inc. of Cupertino, Calif. In a number of embodiments, third sub-assembly 170 can include a strain relief (not shown), which can connect universal serial bus plug 171 to second end 107 of second electrical cable 105, and can allow second electrical cable 105 to bend proximate to universal serial bus plug 171 without cracking or breaking away from universal serial bus plug 171.

In some embodiments, cable dock assembly 100 can include one or more second universal serial bus receptacles 172. In many embodiments, second universal serial bus receptacles 172 can be Type A Universal Serial Bus (USB) receptacles. In various embodiments, second universal serial bus receptacles 172 can support USB 2.0, USB 3.0, USB 3.1, and/or another suitable communication protocol. Second universal serial bus receptacles 172 can facilitate connection of a computing device through cable dock assembly 100 to one or more peripheral devices, such as a USB flash drive and/or other suitable peripheral devices.

In a number of embodiments, cable dock assembly 100 can include one or more second pigtail cables 173. In various embodiments, each of second pigtail cables 173 can connect a different one of second universal serial bus receptacles 172 to third sub-assembly 170. In many embodiments, each of second pigtail cables 173 can attach to third sub-assembly 170 at the strain relief, which can allow second pigtail cables 173 to bend without breaking away from third sub-assembly 170. In a number of embodiments, each of second pigtail cables 173 can have a length of less than 4 in. In other embodiments, each of second pigtail cables 173 can have a length of less than 6 in. In many embodiments, second pigtail cables 173 can have a cross-sectional diameter less than the cross-sectional diameter of either first electrical cable 101 or second electrical cable 105.

In some embodiments, cable dock assembly 100 can include an audio receptacle 174. In many embodiments, audio receptacle 174 can include a 3.5 millimeter (mm) audio receptacle configured to connect to a 3.5 mm Tip-Ring-Sleeve (TRS) phone connector. In a number of embodiments, audio receptacle 174 can support analog audio, and/or can facilitate connection of a computing device through cable dock assembly 100 to audio speakers, such as headphones, earphones, or another suitable speaker system.

In several embodiments, cable dock assembly 100 can include a third pigtail cable 175. In various embodiments, third pigtail cable 175 can connect audio receptacles 175 to third sub-assembly 170. In many embodiments, third pigtail cable 175 can attach to third sub-assembly 170 at the strain relief, which can allow third pigtail cable 175 to bend without breaking away from third sub-assembly 170. In a number of embodiments, third pigtail cable 175 can have a length of less than 4 in. In other embodiments, third pigtail cable 175 can have a length of less than 6. in. In many embodiments, third pigtail cable 175 can have a cross-sectional diameter less than the cross-sectional diameter of either first electrical cable 101 or second electrical cable 105.

In various embodiments, cable dock assembly 100 can include connective elements 176. In certain embodiments, audio receptacle 174 and/or each of second universal serial bus receptacles 172 can include one of connective elements 176. Connective elements 176 can be substantially similar to connective elements 145, and can be configured to removably connect to the outside of second electrical cable 105. For example, connective elements 176 can include rounded snaps configured to partially or fully surround second electrical cable 105. In some embodiments, each of connective elements 176 can be configured to connect to second electrical cable 105 next to another of connective elements 176. For example, in certain embodiments cable dock assembly 100 can include one of second universal serial bus receptacles 172 connected to one of second pigtail cables 173 having approximately the same length as a third pigtail cable 175 connected to audio receptacle 174, and one of connective elements 176 can be located on audio receptacle 174 proximate to the receptacle insertion portion and another of connective elements 176 can be located on second universal serial bus receptacles 172 proximate to the portion connected to second pigtail cable 173, as shown in FIG. 1.

In a number of embodiments, cable dock assembly 100 can include one or more controller chips, described below, which can facilitate operative connections between a computing device connected to universal serial bus plug 171 and various peripheral devices connected to one or more of network receptacle 114, first video display plug 141, first universal serial bus receptacles 143, second universal serial bus receptacles 172, and/or audio receptacle 174. In many embodiments, the controller chips can be fully contained within one or more of first sub-assembly 110, second sub-assembly 140, and/or third sub-assembly 170. In many embodiments, cable dock assembly 100 can advantageously consolidate several peripheral inputs for connection to the computing device. Specifically, in some embodiments, peripheral devices and/or inputs can be connected to cable dock assembly 100 and remain connected, even when the computing device is not connected to cable dock assembly 100. The computing device can advantageously be simply and readily attached to the peripheral devices by connecting only universal serial bus plug 171 to the computing device. The computing device can likewise be simply and readily detached from the peripheral devices by disconnecting only universal serial bus plug 171 from the computing device. In many embodiments, cable dock assembly 100 can provide power to the computing device and/or the peripheral devices, and/or can facilitate charging batteries in the computing device and/or the peripheral devices.

In various embodiments, cable dock assembly 100 can be configured such that, when first sub-assembly 110 is attached to a power source, second sub-assembly 140 is attached to a video display, and third sub-assembly 170 is attached to the computing device on a desk or other surface, first sub-assembly 110, second sub-assembly 140, and third sub-assembly 170 each do not touch the surface. The sub-assemblies (e.g., 110, 140, 170) of cable dock assembly 100 can have a zero footprint on the surface, which can advantageously allow for docking a computing device at a desk without electronic components cluttering the surface of the desk when the computing device is or is not docked to cable dock assembly 100. In many embodiments, first sub-assembly 110, second sub-assembly 140, and/or third sub-assembly 170 can each be no larger than 80 mm by 40 mm by 125 mm and/or can have a volume of less than or equal to 400 cubic centimeters (cm³).

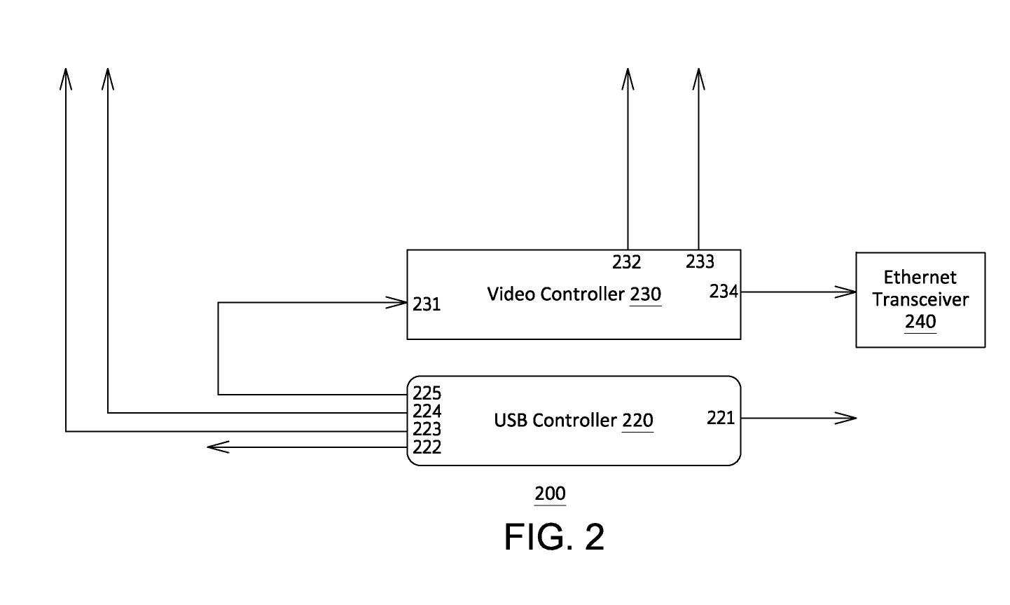

Turning ahead in the drawings, FIG. 2 illustrates a schematic view of control circuitry 200 for an embodiment of a cable dock assembly, such as cable dock assembly 100 (FIG. 1). Control circuitry 200 is merely exemplary and embodiments of the control circuitry are not limited to the embodiments presented herein. The control circuitry can be employed in many different embodiments or examples not specifically depicted or described herein. In many embodiments, control circuitry 200 can include one or more controller chips, such as a first universal serial bus hub controller 220, a video controller 230, and/or an Ethernet transceiver 240.

In some embodiments, first universal serial bus hub controller 220 can be fully housed within first sub-assembly 110 (FIG. 1). In a number of embodiments, first universal serial bus hub controller 220 can be fully housed within first housing 111 (FIG. 1). In other embodiments, first universal serial bus hub controller 220 can be fully housed within second housing 112 (FIG. 1). In certain embodiments, first universal serial bus hub controller 220 can control the routing of data between one upstream USB port and four downstream USB ports, and can be a VIA VL811 SuperSpeed USB 3.0 Hub Controller or a VIA VL812 SuperSpeed USB 3.0 Hub Controller, sold by VIA Labs, Inc. of Taipei, Taiwan. First universal serial bus hub controller 220 can be electrically coupled to the power adapter in first sub-assembly 110 (FIG. 1).

In a number of embodiments, first universal serial bus hub controller 220 can include an upstream universal serial bus port 221 and four downstream universal serial bus ports 222-225. Upstream universal serial bus port 221 and/or downstream universal serial bus ports 222-225 can support USB 3.0. In many embodiments, upstream universal serial bus port 221 can be electrically coupled to universal serial bus plug 171 (FIG. 1). In certain embodiments, downstream universal serial bus port 222 can be electrically coupled to second universal serial bus receptacle 172 (FIG. 1), downstream universal serial bus port 223 can be electrically coupled to one of first universal serial bus receptacles 143 (FIG. 1), and/or downstream universal serial bus port 224 can be electrically coupled to another one of first universal serial bus receptacles 143 (FIG. 1).

In many embodiments, video controller 230 can be fully housed within first sub-assembly 110 (FIG. 1). In certain embodiments, video controller 230 can be fully housed within second housing 112 (FIG. 1). In other embodiments, video controller 230 can be fully housed within first housing 111 (FIG. 1). In a number of embodiments, video controller 230 can control the routing of data between one upstream USB port, a downstream video port, a downstream audio port, and an Ethernet port, and can be a DisplayLink™ DL-3700, sold by DisplayLink Corp. of Palo Alto, Calif. Video controller 230 can be electrically coupled to the power adapter in first sub-assembly 110 (FIG. 1).

In several embodiments, video controller 230 can include an upstream universal serial bus port 231, which can be electrically coupled to downstream universal serial bus port 225 of first universal serial bus hub controller 220. In many embodiments, video controller 230 can include a video display port 232. In certain embodiments, video display port 232 can be electrically coupled to first video display plug 141 (FIG. 1). In some embodiments, video display port 232 can support DVI or another suitable video display interface. In a number of embodiments, video controller 230 can include an audio port 233. Audio port 233 can be electrically coupled to audio receptacle 174 (FIG. 1). In certain embodiments, audio port 233 can support analog audio output, TOSLINK, or another suitable audio output interface.

In many embodiments, video controller 230 can include an Ethernet port 234, which can be coupled to Ethernet transceiver 240. Ethernet transceiver 240 can be fully housed within first sub-assembly 110 (FIG. 1). In certain embodiments, Ethernet transceiver 240 can be fully housed within housing 111 (FIG. 1). Ethernet transceiver 240 can provide physical layer functions to transmit and receive Ethernet packets, and can be a Realtek RTL8211E, sold by Realtek Semiconductor Corp. of Hsinchu City, Taiwan. In many embodiments, Ethernet transceiver 240 can be electrically coupled to network receptacle 114 (FIG. 1), which can be an RJ45 Ethernet receptacle.

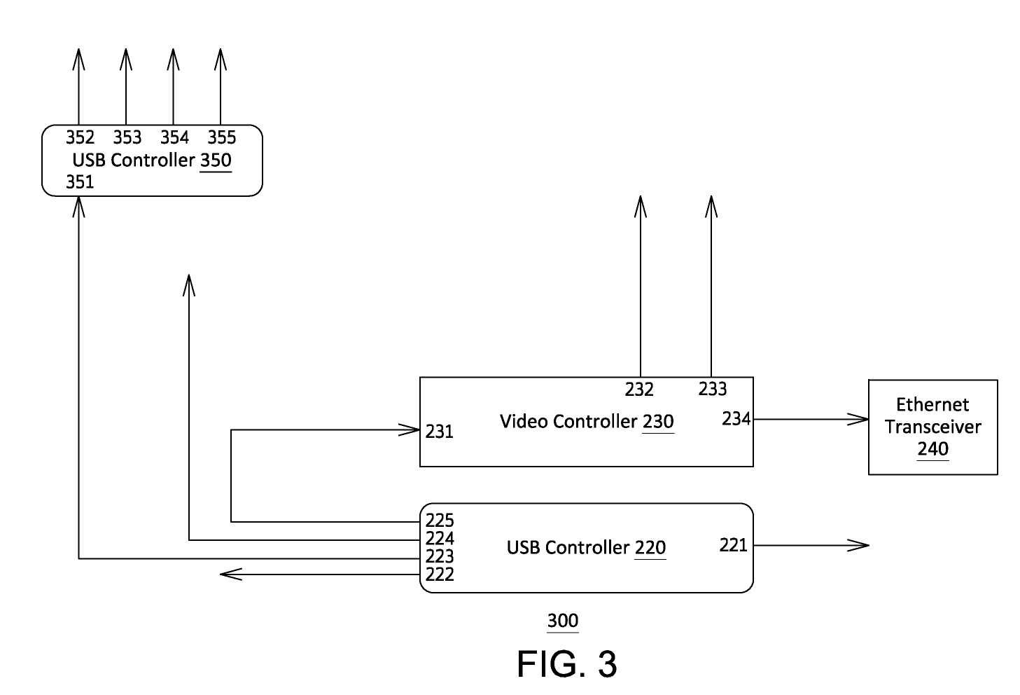

Turning ahead in the drawings, FIG. 3 illustrates a schematic view of control circuitry 300 for another embodiment of a cable dock assembly, such as cable dock assembly 100 (FIG. 1), but which can provide an additional number of universal serial bus receptacles for connecting additional peripheral devices. Control circuitry 300 is merely exemplary and embodiments of the control circuitry are not limited to the embodiments presented herein. The control circuitry can be employed in many different embodiments or examples not specifically depicted or described herein. Control circuitry 300 can be similar to control circuitry 200 (FIG. 2), and various components and/or constructions of control circuitry 300 can be identical or substantially similar to various components of control circuitry 200 (FIG. 2). In many embodiments, control circuitry 300 can include one or more controller chips, such as first universal serial bus hub controller 220, video controller 230, Ethernet transceiver 240, and/or a second universal serial bus hub controller 350.

In a number of embodiments, upstream universal serial bus port 221 of first universal serial bus hub controller 220 can be electrically coupled to universal serial bus plug 171 (FIG. 1). In certain embodiments, downstream universal serial bus port 222 and/or downstream universal serial bus port 224 can be electrically coupled to second universal serial bus receptacles 172 (FIG. 1) and/or first universal serial bus receptacles 143 (FIG. 1). In many embodiments, downstream universal serial bus port 225 can be electrically coupled to upstream universal serial bus port 231 of video controller 230. In many embodiments, video display port 232 can be electrically coupled to first video display plug 141 (FIG. 1), audio port 233 can be electrically coupled to audio receptacle 174 (FIG. 1), and Ethernet port 234 can be coupled to Ethernet transceiver 240. Ethernet transceiver 240 can be electrically coupled to network receptacle 114 (FIG. 1).

In some embodiments, second universal serial bus hub controller 350 can be fully housed within second sub-assembly 140 (FIG. 1). For example, second universal serial bus hub controller 350 can be molded within strain relief 142 (FIG. 1). In other embodiments, second universal serial bus hub controller 350 can be fully housed within first sub-assembly 110 (FIG. 1). In certain embodiments, second universal serial bus hub controller 350 can be fully housed within first housing 111 (FIG. 1). In certain other embodiments, second universal serial bus hub controller 350 can be fully housed within second housing 112 (FIG. 1). In certain embodiments, second universal serial bus hub controller 350 can control the routing of data between one upstream USB port and four downstream USB ports, and can be a Terminus FE1.1 USB 2.0 4-Port Hub Controller, sold by Terminus Technology Inc. of Taipei, Taiwan. Second universal serial bus hub controller 350 can be electrically coupled to the power adapter in first sub-assembly 110 (FIG. 1).

In a number of embodiments, second universal serial bus hub controller 350 can include an upstream universal serial bus port 351 and four downstream universal serial bus ports 352-355. In many embodiments, upstream universal serial bus port 351 and/or downstream universal serial bus ports 352-355 can support USB 2.0. In many embodiments, upstream universal serial bus port 351 can be electrically coupled to downstream universal serial bus port 223 of first universal serial bus hub controller 220. In certain embodiments, downstream universal serial bus ports 352-355 can each be electrically coupled to a different one of first universal serial bus receptacles 143 (FIG. 1). In certain other embodiments, downstream universal serial bus ports 352-353 can each be electrically coupled to a different one of first universal serial bus receptacles 143 (FIG. 1), and downstream universal serial bus ports 354-355 can each be electrically coupled a different one of second universal serial bus receptacles 172.

By using second universal serial bus hub controller 350, control circuitry 300 can advantageously be used to connect up to six USB peripheral devices, whereas control circuitry 200 can be used to connect up to three USB peripheral devices. In some embodiments, first universal serial bus receptacles 143 (FIG. 1) and/or second universal serial bus receptacles 172 (FIG. 1) can each be connected to a single pigtail cable (e.g., one of first pigtail cables 144 (FIG. 1) or second pigtail cables 173 (FIG. 1)). In other embodiments, one or more of pigtail cables 144 (FIG. 1) and/or second pigtail cables 173 (FIG. 1) can each be connected to more than one first universal serial bus receptacles 143 (FIG. 1) and/or second universal serial bus receptacles 172 (FIG. 1). In some embodiments, for example, one of second pigtail cable 173 (FIG. 1) can connect to a molded cluster of four second universal serial bus receptacles 172 (FIG. 1).

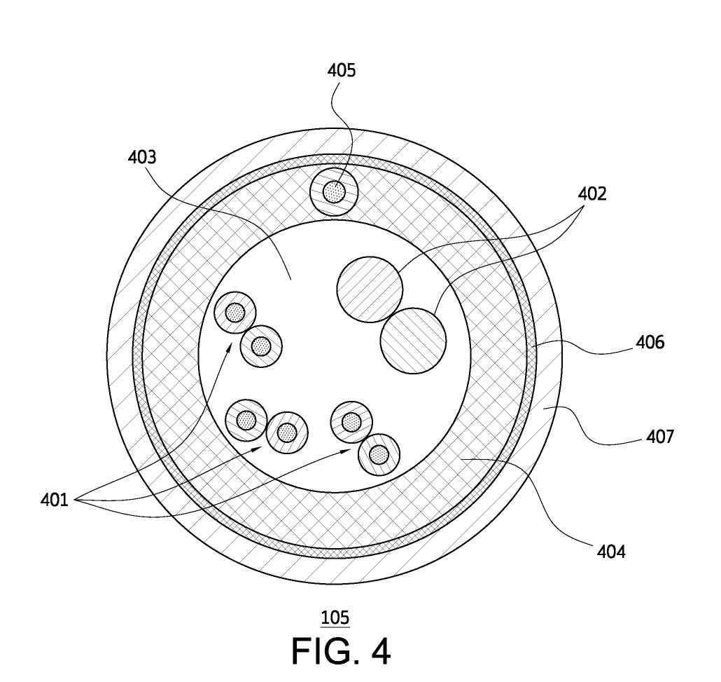

Turning ahead in the drawings, FIG. 4 illustrates a cross-sectional view of second electrical cable 105 (FIG. 1). In many embodiments, second electrical cable 105 can include three sets of stranded twisted pair 401. In certain embodiments, each of stranded twisted pair sets 401 can include a foil shield outer braid. In a number of embodiments, second electrical cable 105 can include a twin coaxial pair 402. In certain embodiments, twin coaxial pair 402 can include a solid bare copper core. In many embodiments, second electrical cable 105 can include filler material 403. In various embodiments, second electrical cable 105 can include a braid 404, which can surround stranded twisted pair sets 401, twin coaxial pair 402, and/or filler material 403. Braid 404 can be made of aluminum. In some embodiments, braid 404 can include a drain wire 405. In several embodiments, second electrical cable 105 can include a foil shield 406 surrounding braid 404. In many embodiments, foil shield 406 can provide electromagnetic shielding. In a number of embodiments, second electrical cable 105 can include an outer sheath 407 surrounding foil shield 406. Outer sheath 407 can be made of polyvinyl chloride (PVC), Teflon®, and/or another suitable material. In many embodiments, outer sheath 407 can be Class 2 (CL2)-rated and/or plenum rated. In some embodiments, a ferrite (not shown) can be attached to second electrical cable 105 at or proximate to second end 107 (FIG. 1), which can be configured to limit electromagnetic noise in signal transmissions across second electrical cable 105. In many embodiments, second electrical cable 105 can have a length of between 1 and 4 feet (ft).

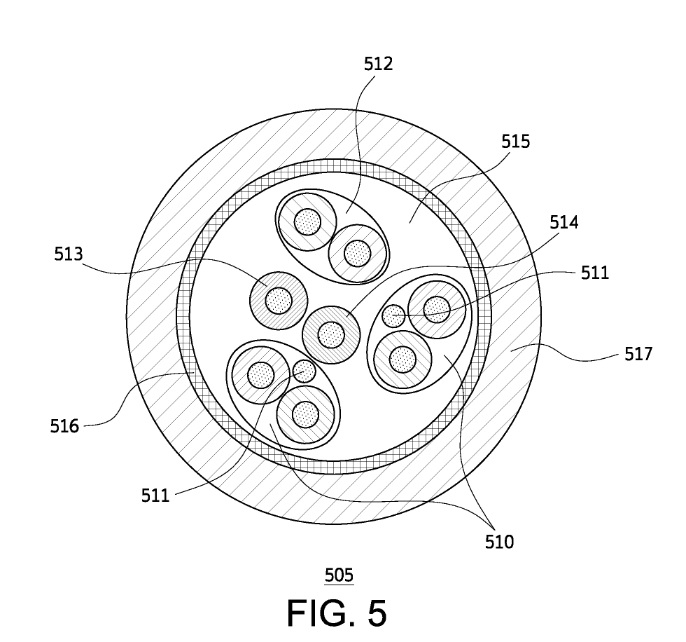

Turning ahead in the drawings, FIG. 5 illustrates a cross-sectional view of a second electrical cable 505. Second electrical cable 505 can be similar to second electrical cable 105 (FIGS. 1 and 4), and various components and/or constructions of second electrical cable 505 can be similar to various components of second electrical cable 105 (FIGS. 1 and 4). In many embodiments, second electrical cable 505 can include two sets of shielded twisted pair 510. In certain embodiments, each of shielded twisted pair sets 510 can include a drain wire 511, which can be integrated in the shielding. In a number of embodiments, second electrical cable 505 can include a shielded differential pair 412. In many embodiments, second electrical cable 505 can include a power wire 513, a ground wire 514, and/or filler material 515. In various embodiments, second electrical cable 505 can include a braid 516, which can surround the internal components, such as shielded twisted pair sets 510, shielded differential pair 412, power wire 513, ground wire 514, and/or filler material 515. Braid 516 can be made of aluminum or another suitable material, and can provide electromagnetic shielding. In a number of embodiments, second electrical cable 505 can include an outer sheath 517 surrounding braid 516. Outer sheath 517 can be made of polyvinyl chloride (PVC), Teflon®, and/or another suitable material. In many embodiments, outer sheath 407 can be Class 2 (CL2)-rated and/or plenum rated.

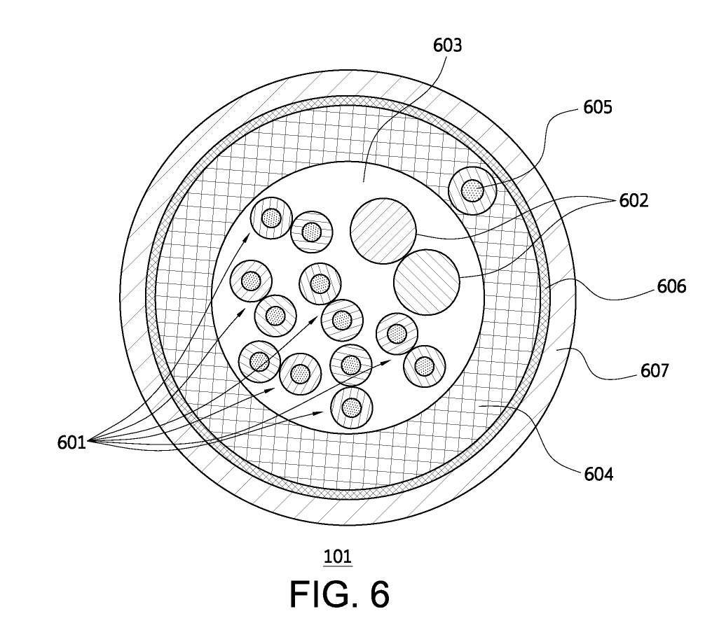

Turning ahead in the drawings, FIG. 6 illustrates a cross-sectional view of first electrical cable 101 (FIG. 1). In many embodiments, such as embodiments of the cable dock assembly that include second universal serial bus hub controller 350 (FIG. 3), first electrical cable 101 can include six sets of shielded twisted pair 601. In other embodiments, such as embodiments of the cable dock assembly that do not include second universal serial bus hub controller 350 (FIG. 3), first electrical cable 101 can include five sets of shielded twisted pair 601. In other embodiments, first electrical cable 101 can include additional sets of shielded twisted pair 601. In certain embodiments, each of shielded twisted pair sets 601 can include an aluminum braided overwrap. In a number of embodiments, first electrical cable 101 can include a twin coaxial pair 602. In certain embodiments, twin coaxial pair 602 can include a solid bare copper core. In many embodiments, first electrical cable 101 can include filler material 603. In various embodiments, first electrical cable 101 can include a braid 604, which can surround shielded twisted pair sets 601, twin coaxial pair 602, and/or filler material 603. Braid 604 can be made of aluminum. In some embodiments, braid 604 can include a drain wire 605. In several embodiments, first electrical cable 101 can include a foil shield 606 surrounding braid 604. In many embodiments, foil shield 606 can provide electromagnetic shielding. In a number of embodiments, first electrical cable 101 can include an outer sheath 607 surrounding foil shield 606. Outer sheath 607 can be made of polyvinyl chloride (PVC), Teflon®, and/or another suitable material. In many embodiments, outer sheath 607 can be Class 2 (CL2)-rated and/or plenum rated. In some embodiments, a ferrite (not shown) can be attached to first electrical cable 101 at or proximate to second end 102 (FIG. 1), which can be configured to limit electromagnetic noise in signal transmissions across first electrical cable 101. In many embodiments, first electrical cable 101 can have a length of between 1 and 8 ft.

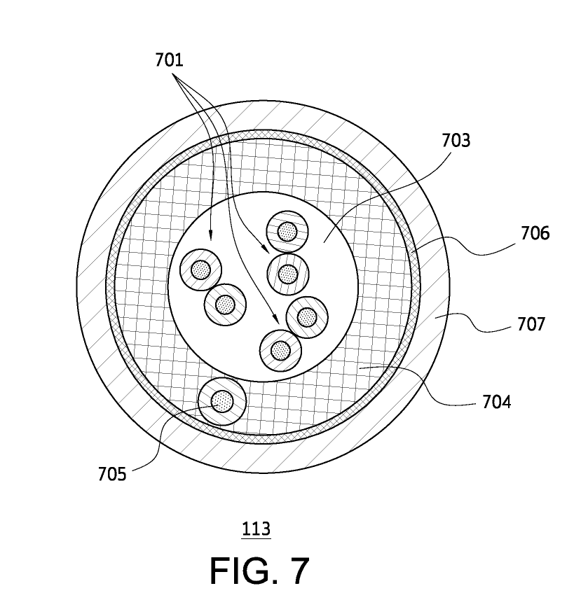

Turning ahead in the drawings, FIG. 7 illustrates a cross-sectional view of housing-to-housing electrical cable 113 (FIG. 1). Housing-to-housing electrical cable 113 can be used when first sub-assembly 101 includes first housing 111 and second housing 112. In many embodiments, housing-to-housing electrical cable 113 can include three sets of shielded twisted pair 701. In certain embodiments, each of shielded twisted pair sets 701 can include an aluminum braided overwrap. In many embodiments, housing-to-housing electrical cable 113 can include filler material 703. In various embodiments, housing-to-housing electrical cable 113 can include a braid 704, which can surround shielded twisted pair sets 701 and/or filler material 703. Braid 704 can be made of aluminum. In some embodiments, braid 704 can include a drain wire 705. In several embodiments, housing-to-housing electrical cable 113 can include a foil shield 706 surrounding braid 704. In many embodiments, foil shield 706 can provide electromagnetic shielding. In a number of embodiments, housing-to-housing electrical cable 113 can include an outer sheath 707 surrounding foil shield 706. Outer sheath 707 can be made of polyvinyl chloride (PVC), Teflon®, and/or another suitable material. In many embodiments, outer sheath 707 can be Class 2 (CL2)-rated and/or plenum rated. In many embodiments, housing-to-housing electrical cable 113 can have a length of between 0.5 and 12 in.

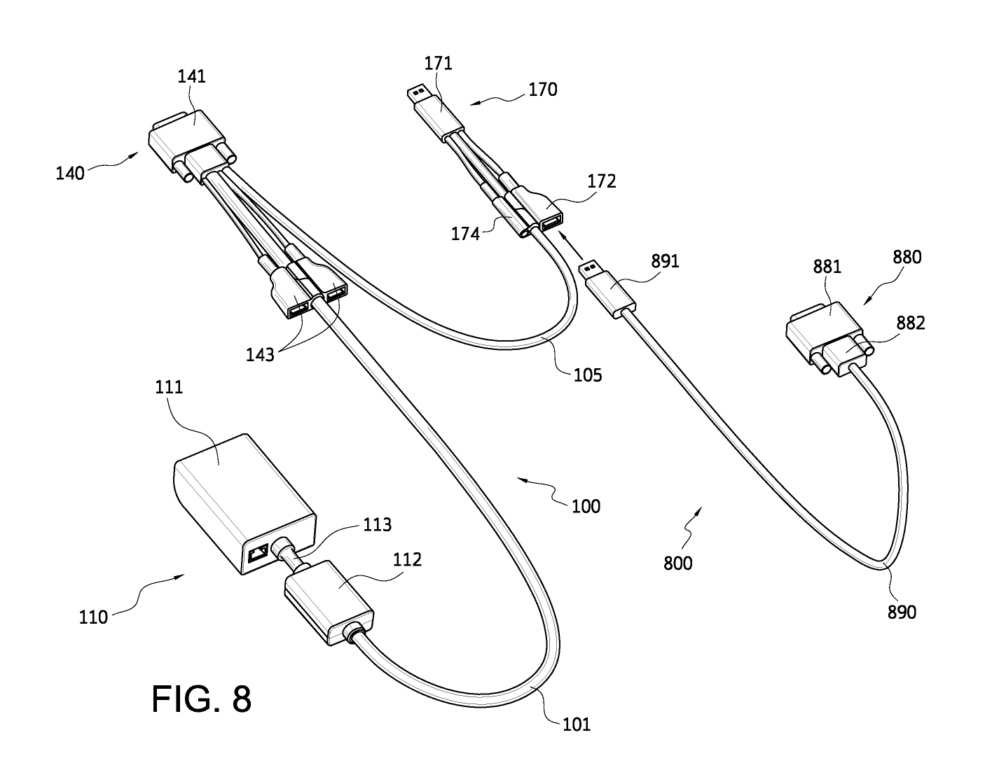

Turning ahead in the drawings, FIG. 8 illustrates a perspective view of a video attachment cable 800, which can be used with cable dock assembly 100 to facilitate connecting a computing device to two video displays, among other peripherals. Video attachment cable 800 is merely exemplary and embodiments of the video attachment cable are not limited to the embodiments presented herein. The video attachment cable can be employed in many different embodiments or examples not specifically depicted or described herein. In many embodiments, video attachment cable 800 can include a universal serial bus plug 891. Universal serial bus plug 891 can be configured to removably attach to second universal serial bus receptacles 172 or first universal serial bus receptacles 143 of cable dock assembly 100. In various embodiments, universal serial bus plug 891 can be a Type A USB plug. In many embodiments, universal serial bus plug 891 can support USB 3.0, and can be plugged into a universal serial bus receptacle of cable dock assembly 100 that supports USB 3.0.

In many embodiments, video attachment cable 800 can include a fourth sub-assembly 880. Fourth sub-assembly 880 can include a video display plug 881 and/or a strain relief 882. Video display plug 881 can be configured to removably attach to a second video display. For example, video display plug 881 can include a DVI-I male connector, as shown in FIG. 8. In various other embodiments, video display plug 881 can include a DVI-D connector, a DVI-A connector, a VGA connector, an HDMI connector, a DP connector, a Thunderbolt™ connector, or another suitable connector for a video display interface. In some embodiments, video display plug 881 can include an adapter and/or controller (not shown) configured to convert DVI-I to VGA, DVI-I to HDMI, DP to HDMI, DVI-I to DP, or another suitable conversion. For example, in some embodiments, a DP501 DP Transmitter, sold by Parade Technologies, Inc. of Santa Clara, Calif., can be used to convert DVI-I or HDMI to DP.

In a number of embodiments, universal serial bus plug 891 can be attached to video display plug 881 by a third electrical cable 890. In a number of embodiments, third electrical cable 890 can be attached to video display plug 881 by strain relief 882. In many embodiments, strain relief 882 can allow third electrical cable 890 to bend proximate to video display plug 891 without cracking or breaking away from video display plug 891. In various embodiments, strain relief 882 can include a controller chip (not shown) configured to convert a USB signals to the video display interface format used by video display plug 881.

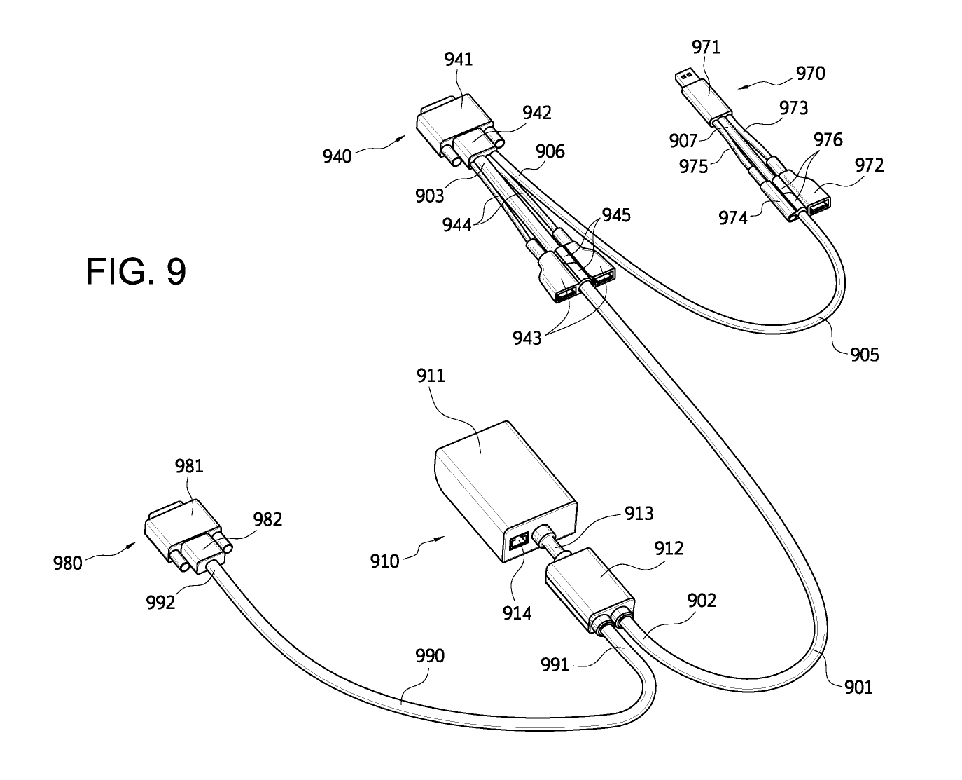

Turning ahead in the drawings, FIG. 9 illustrates a perspective view of a cable dock assembly 900, which can facilitate connecting a computing device to two video displays, among other peripherals. Cable dock assembly 900 is merely exemplary and embodiments of the cable dock assembly are not limited to the embodiments presented herein. The cable dock assembly can be employed in many different embodiments or examples not specifically depicted or described herein. Cable dock assembly 900 can be similar to cable dock assembly 100 (FIG. 1), and various components and/or constructions of cable dock assembly 900 can be identical or substantially similar to various components of cable dock assembly 100 (FIG. 1).

In some embodiments, cable dock assembly 900 can include a first sub-assembly 910, a second sub-assembly 940, a third sub-assembly 970, and/or a fourth sub-assembly 980. Each of first sub-assembly 910, second sub-assembly 940, third sub-assembly 970, and/or fourth sub-assembly 980 can house circuitry, controller chips, plugs, and/or receptacles. In a number of embodiments, cable dock assembly 900 can include a first electrical cable 901, a second electrical cable 905, and/or a third electrical cable 990. First electrical cable 901 can include a first end 902 and/or a second end 903. First end 902 can be attached at first sub-assembly 910 and second end 903 can be attached at second sub-assembly 940. First electrical cable 901 can be identical or substantially similar to first electrical cable 101 (FIG. 1). Second electrical cable 905 can include a first end 906 and/or a second end 907. First end 906 can be attached at second sub-assembly 940 and second end 907 can be attached at third sub-assembly 970. Second electrical cable 905 can be identical or substantially similar to second electrical cable 105 (FIG. 1). Third electrical cable 990 can include a first end 991 and/or a second end 992. First end 991 can be attached at first sub-assembly 910 and second end 992 can be attached at fourth sub-assembly 980. Third electrical cable 990 can be similar to first electrical cable 901.

In a number of embodiments, first sub-assembly 910 can be similar to first sub-assembly 110 (FIG. 1), and various components and/or constructions of first sub-assembly 910 can be identical or substantially similar to various components of first sub-assembly 110 (FIG. 1). For example, first sub-assembly 910 can include a first housing 911, a second housing 912, a housing-to-housing electrical cable 913, and/or a network receptacle 914. First housing 911 can be identical or substantially similar to first housing 111 (FIG. 1), second housing 912 can be identical or substantially similar to second housing 112 (FIG. 1), housing-to-housing electrical cable 913 can be identical or substantially similar to housing-to-housing electrical cable 113 (FIG. 1), and/or network receptacle 914 can be identical or substantially similar to network receptacle 114 (FIG. 1).

In many embodiments, second sub-assembly 940 can be similar to second sub-assembly 140 (FIG. 1), and various components and/or constructions of second sub-assembly 940 can be identical or substantially similar to various components of second sub-assembly 140 (FIG. 1). For example, second sub-assembly 940 can include a first video display plug 941 and/or a strain relief 942. First video display plug 941 can be configured to removably attach to a first video display. First video display plug 941 can be identical or substantially similar to first video display plug 141 (FIG. 1), and/or strain relief 942 can be identical or substantially similar to strain relief 142 (FIG. 1). In various embodiments, cable dock assembly 900 can include one or more first universal serial bus receptacles 943. In some embodiments, first universal serial bus receptacles 943 can be attached to second sub-assembly 940 by one or more first pigtail cables 944. In a number of embodiments, first universal serial bus receptacles 943 can include connective elements 945. First universal serial bus receptacles 943 can be identical or substantially similar to first universal serial bus receptacles 143 (FIG. 1), first pigtail cables 944 can be identical or substantially similar to first pigtail cables 144 (FIG. 1), and/or connective elements 945 can be identical or substantially similar to connective elements 145 (FIG. 1).

In many embodiments, third sub-assembly 970 can be similar to third sub-assembly 170 (FIG. 1), and various components and/or constructions of third sub-assembly 970 can be identical or substantially similar to various components of third sub-assembly 170 (FIG. 1). For example, third sub-assembly 970 can include a universal serial bus plug 971. Universal serial bus plug 971 can be configured to removably attach to a computing device and can be identical or substantially similar to universal serial bus plug 171 (FIG. 1). In various embodiments, cable dock assembly 900 can include one or more second universal serial bus receptacles 972. In some embodiments, second universal serial bus receptacles 972 can be attached to third sub-assembly 970 by one or more second pigtail cables 973. In a number of embodiments, cable dock assembly 900 can include an audio receptacle 974. Audio receptacle 974 can be attached to third sub-assembly 970 by a third pigtail cable 975. In certain embodiments, second universal serial bus receptacles 972 and/or audio receptacle 974 can include connective elements 976. Second universal serial bus receptacles 972 can be identical or substantially similar to second universal serial bus receptacles 172 (FIG. 1), second pigtail cables 973 can be identical or substantially similar to second pigtail cables 173 (FIG. 1), audio receptacle 974 can be identical or substantially similar to audio receptacle 174 (FIG. 1), third pigtail cable 975 can be identical or substantially similar to third pigtail cable 175 (FIG. 1), and/or connective elements 976 can be identical or substantially similar to connective elements 176 (FIG. 1).

In various embodiments, fourth sub-assembly 180 can include a second video display plug 981 and/or a strain relief 982. Second video display plug 981 can be configured to removably attach to a second video display, and can facilitate connection of a computing device through cable dock assembly 900 to the second video display. For example, second video display plug 981 can include a DVI-I male connector, as shown in FIG. 9. In various other embodiments, second video display plug 981 can include a DVI-D connector, a DVI-A connector, a VGA connector, an HDMI connector, a DP connector, a Thunderbolt™ connector, or another suitable connector for a video display interface. In some embodiments, second video display plug 981 can include an adapter and/or controller (not shown) configured to convert DVI-I to VGA, DVI-I to HDMI, DP to HDMI, DVI-I to DP, or another suitable conversion.

In a number of embodiments, strain relief 982 can connect second video display plug 981 to second end 992 of third electrical cable 990, and/or can allow third electrical cable 990 to bend proximate to second video display plug 981 without cracking or breaking away from second video display plug 981. In some embodiments, strain relief 982 can include additional circuitry, as described below.

In a number of embodiments, cable dock assembly 900 can include one or more controller chips, described below, which can facilitate operative connections between a computing device connected to universal serial bus plug 971 and various peripheral devices connected to one or more of network receptacle 914, first video display plug 941, second video display plug 981, first universal serial bus receptacles 943, second universal serial bus receptacles 972, and/or audio receptacle 974. In many embodiments, cable dock assembly 900 can advantageously consolidate several peripheral inputs for connection to the computing device. In many embodiments, the controller chips can be fully contained within one or more of first sub-assembly 910, second sub-assembly 940, third sub-assembly 970, and/or fourth sub-assembly 980.

In various embodiments, cable dock assembly 900 can be configured such that, when first sub-assembly 910 is attached to a power source, second sub-assembly 940 is attached to a first video display, third sub-assembly 970 is attached to the computing device on a desk or other surface, and fourth sub-assembly 980 is attached to a second video display, first sub-assembly 910, second sub-assembly 940, third sub-assembly 970, and/or fourth sub-assembly 980 each do not touch the surface. The sub-assemblies (e.g., 910, 940, 970, 980) of cable dock assembly 900 can have a zero footprint on the surface, which can advantageously allow for docking a computing device at a desk without electronic components cluttering the surface of the desk when the computing device is or is not docked to cable dock assembly 900. In many embodiments, first sub-assembly 910, second sub-assembly 940, third sub-assembly 970, and/or fourth sub-assembly 980 can each be no larger than 80 mm by 40 mm by 125 mm and/or can have a volume of less than or equal to 400 cm³.

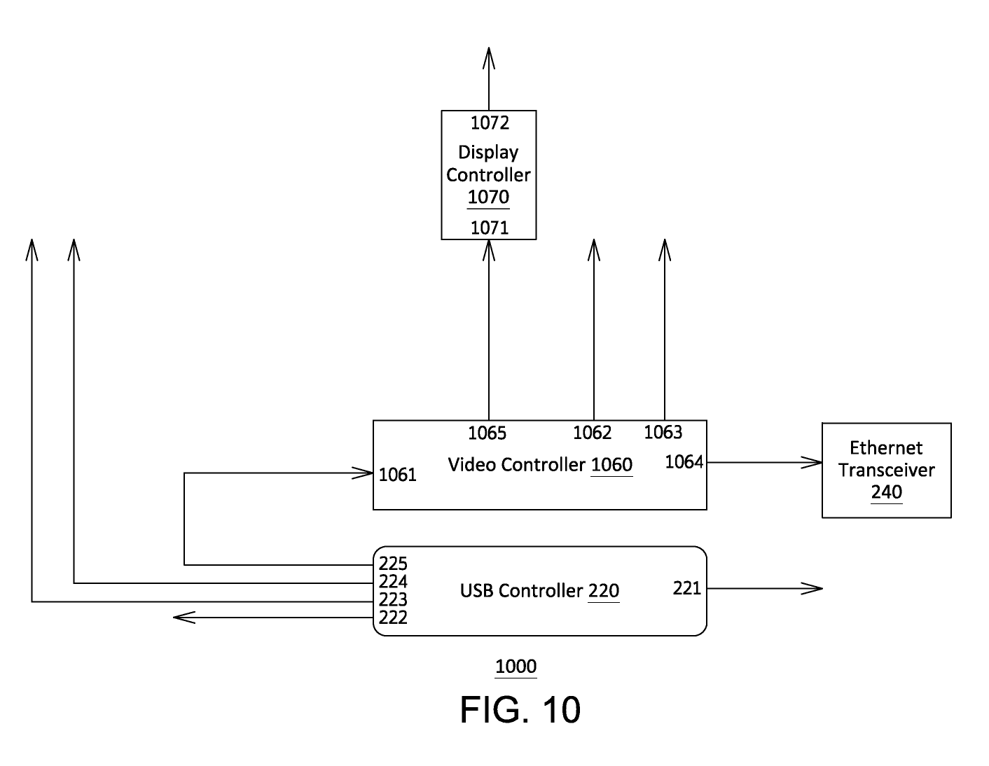

Turning ahead in the drawings, FIG. 10 illustrates a schematic view of control circuitry 1000 for an embodiment of a cable dock assembly configured to removably attach to two video displays, such as cable dock assembly 900 (FIG. 1). Control circuitry 1000 is merely exemplary and embodiments of the control circuitry are not limited to the embodiments presented herein. The control circuitry can be employed in many different embodiments or examples not specifically depicted or described herein. Control circuitry 1000 can be similar to control circuitry 200 (FIG. 2) and/or control circuitry 300 (FIG. 3), and various components and/or constructions of control circuitry 1000 can be identical or substantially similar to various components of control circuitry 200 (FIG. 2) and/or control circuitry 300 (FIG. 3). In many embodiments, control circuitry 1000 can include one or more controller chips, such as first universal serial bus hub controller 220, a video controller 1060, Ethernet transceiver 240, and/or a display controller 1070.

In some embodiments, first universal serial bus hub controller 220 can be fully housed within first sub-assembly 910 (FIG. 9). In a number of embodiments, first universal serial bus hub controller 220 can be fully housed within first housing 911 (FIG. 9). In other embodiments, first universal serial bus hub controller 220 can be fully housed within second housing 912 (FIG. 9). In a number of embodiments, upstream universal serial bus port 221 of first universal serial bus hub controller 220 can be electrically coupled to universal serial bus plug 971 (FIG. 9). In certain embodiments, downstream universal serial bus port 222 can be electrically coupled to second universal serial bus receptacle 972 (FIG. 9), downstream universal serial bus port 223 can be electrically coupled to one of first universal serial bus receptacles 943 (FIG. 9), and/or downstream universal serial bus port 224 can be electrically coupled to another one or first universal serial bus receptacles 943 (FIG. 9)

In many embodiments, video controller 1060 can be fully housed within first sub-assembly 910 (FIG. 9). In certain embodiments, video controller 1060 can be fully housed within second housing 912 (FIG. 9). In other embodiments, video controller 1060 can be fully housed within first housing 911 (FIG. 9). In a number of embodiments, video controller 1060 can control the routing of data between one upstream USB port, two downstream video ports, a downstream audio port, and an Ethernet port, and can be a DisplayLink™ DL-3900, sold by DisplayLink Corp. of Palo Alto, Calif. Video controller 1060 can be electrically coupled to the power adapter in first sub-assembly 910 (FIG. 9).

In several embodiments, video controller 1060 can include an upstream universal serial bus port 1061, which can be electrically coupled to downstream universal serial bus port 225 of first universal serial bus hub controller 220. In many embodiments, video controller 1060 can include a first video display port 1062. In certain embodiments, video display port 1062 can be electrically coupled to first video display plug 941 (FIG. 9). In some embodiments, first video display port 1062 can support DVI or another suitable video display interface. In a number of embodiments, video controller 1060 can include an audio port 1063. Audio port 1063 can be electrically coupled to audio receptacle 974 (FIG. 9). In certain embodiments, audio port 1063 can support analog audio output, TOSLINK, or another suitable audio output interface.

In many embodiments, video controller 1060 can include an Ethernet port 1064, which can be coupled to Ethernet transceiver 240. Ethernet transceiver 240 can be fully housed within first sub-assembly 910 (FIG. 9). In certain embodiments, Ethernet transceiver 240 can be fully housed within housing 911 (FIG. 9). In many embodiments, Ethernet transceiver 240 can be electrically coupled to network receptacle 914 (FIG. 9), which can be an RJ45 Ethernet receptacle.

In some embodiments, video controller 1060 can include a second video display port 1065. In certain embodiments, second video display port 1065 can be electrically coupled to second video display plug 981 (FIG. 9). In other embodiments, such as shown in FIG. 10, second video display port 1065 can be electrically coupled to an upstream port 1071 of display controller 1070. In certain embodiments, display controller 1070 can be fully housed within fourth sub-assembly 980 (FIG. 9). For example, display controller 1070 can be molded within strain relief 982 (FIG. 9). In certain other embodiments, display controller 1070 can be fully housed within first sub-assembly 910 (FIG. 1). In various embodiments, display controller 1070 can convert an HDMI signals to DP signals, and can be a DP501 DP Transmitter, sold by Parade Technologies, Inc. of Santa Clara, Calif. In certain embodiments, a downstream port 1072 of display controller 1070 can be electrically coupled to second video display plug 981 (FIG. 9).

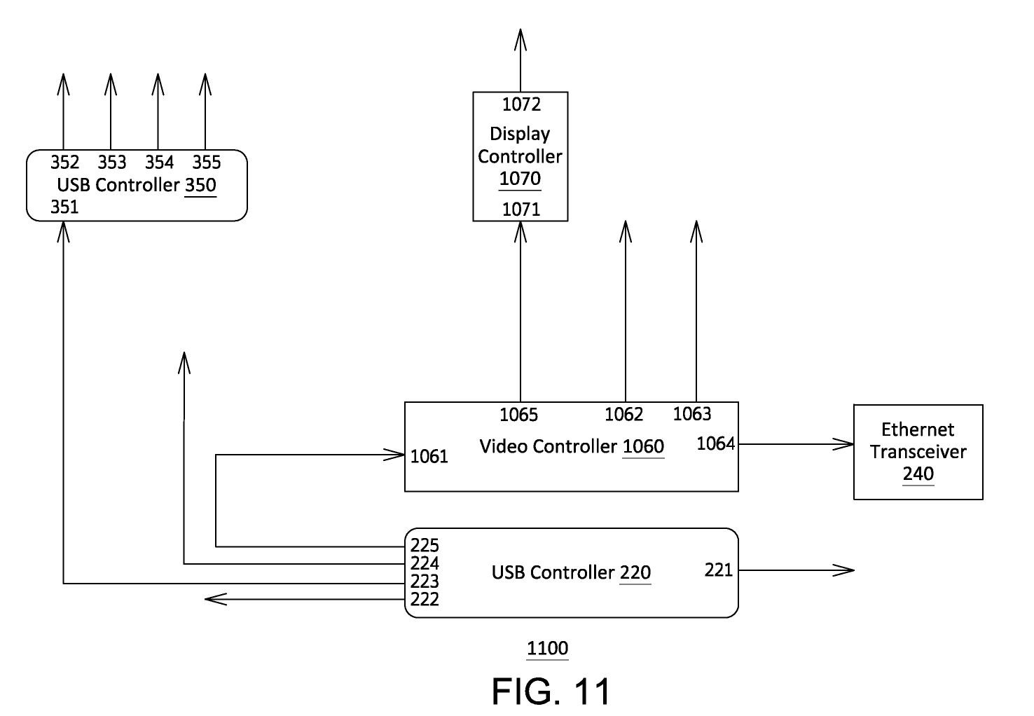

Turning ahead in the drawings, FIG. 11 illustrates a schematic view of control circuitry 1100 for another embodiment of a cable dock assembly configured to removably attach to two video displays, such as cable dock assembly 900 (FIG. 9), but which can provide an additional number of universal serial bus receptacles for connecting additional peripheral devices. Control circuitry 1100 is merely exemplary and embodiments of the control circuitry are not limited to the embodiments presented herein. The control circuitry can be employed in many different embodiments or examples not specifically depicted or described herein. Control circuitry 1100 can be similar to control circuitry 200 (FIG. 2), control circuitry 300 (FIG. 3), and/or control circuitry 1000 (FIG. 10), and various components and/or constructions of control circuitry 1100 can be identical or substantially similar to various components of control circuitry 200 (FIG. 2), control circuitry 300 (FIG. 3), and/or control circuitry 1000 (FIG. 10). In many embodiments, control circuitry 1100 can include one or more controller chips, such as first universal serial bus hub controller 220, video controller 1060, Ethernet transceiver 240, display controller 1070, and/or a second universal serial bus hub controller 350.

In a number of embodiments, upstream universal serial bus port 221 of first universal serial bus hub controller 220 can be electrically coupled to universal serial bus plug 971 (FIG. 9). In certain embodiments, downstream universal serial bus port 222 and/or downstream universal serial bus port 224 can be electrically coupled to second universal serial bus receptacles 972 (FIG. 9) and/or first universal serial bus receptacles 943 (FIG. 9). In many embodiments, downstream universal serial bus port 225 can be electrically coupled to upstream universal serial bus port 1061 of video controller 1060. In many embodiments, first video display port 1062 can be electrically coupled to first video display plug 941 (FIG. 9), audio port 233 can be electrically coupled to audio receptacle 974 (FIG. 9), and Ethernet port 234 can be coupled to Ethernet transceiver 240. Ethernet transceiver 240 can be electrically coupled to network receptacle 914 (FIG. 9). Second video display port 1065 can be electrically coupled to upstream port 1071 of display controller 1070. Downstream port 1072 of display controller 1070 can be electrically coupled to second video display plug 981 (FIG. 9). In other embodiments, second video display port 1065 can be electrically coupled to second video display plug 981 (FIG. 9).

In some embodiments, second universal serial bus hub controller 350 can be fully housed within second sub-assembly 940 (FIG. 9). For example, second universal serial bus hub controller 350 can be molded within strain relief 942 (FIG. 9). In other embodiments, second universal serial bus hub controller 350 can be fully housed within first sub-assembly 910 (FIG. 9). In certain embodiments, second universal serial bus hub controller 350 can be fully housed within first housing 911 (FIG. 9). In certain other embodiments, second universal serial bus hub controller 350 can be fully housed within second housing 912 (FIG. 9). In some embodiments, upstream universal serial bus port 351 of second universal serial bus hub controller 350 can be electrically coupled to downstream universal serial bus port 223 of first universal serial bus hub controller 220. In certain embodiments, downstream universal serial bus ports 352-355 can each be electrically coupled to a different one of first universal serial bus receptacles 943 (FIG. 9). In certain other embodiments, downstream universal serial bus ports 352-353 can each be electrically coupled to a different one of first universal serial bus receptacles 943 (FIG. 9), and downstream universal serial bus ports 354-355 can each be electrically coupled a different one of second universal serial bus receptacles 972.

By using second universal serial bus hub controller 350, control circuitry 1100 can advantageously be used to connect up to six USB peripheral devices, whereas control circuitry 1000 can be used to connect up to three USB peripheral devices. In some embodiments, first universal serial bus receptacles 943 (FIG. 9) and/or second universal serial bus receptacles 972 (FIG. 9) can each be connected to a single pigtail cable (e.g., one of first pigtail cables 944 (FIG. 9) or second pigtail cables 973 (FIG. 9)). In other embodiments, one or more of pigtail cables 944 (FIG. 9) and/or second pigtail cables 973 (FIG. 9) can each be connected to more than one first universal serial bus receptacles 943 (FIG. 9) and/or second universal serial bus receptacles 972 (FIG. 9). In some embodiments, for example, one of second pigtail cable 973 (FIG. 9) can connect to a molded cluster of four second universal serial bus receptacles 972 (FIG. 9).

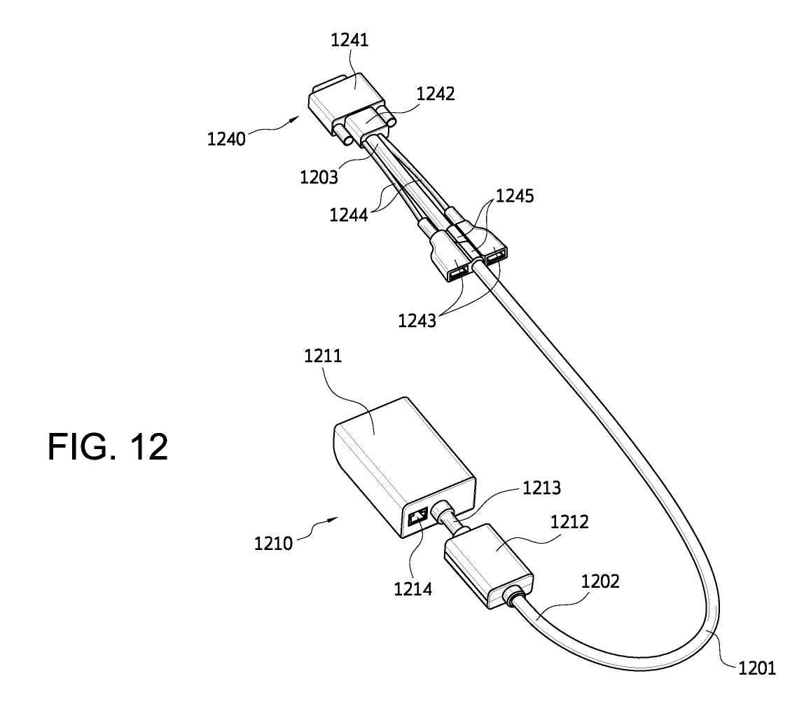

Turning ahead in the drawings, FIG. 12 illustrates a perspective view of a cable dock assembly 1200, which can wirelessly connect to a computing device. Cable dock assembly 1200 is merely exemplary and embodiments of the cable dock assembly are not limited to the embodiments presented herein. The cable dock assembly can be employed in many different embodiments or examples not specifically depicted or described herein. Cable dock assembly 1200 can be similar to cable dock assembly 100 (FIG. 1) and/or cable dock assembly 900 (FIG. 9), and various components and/or constructions of cable dock assembly 1200 can be identical or substantially similar to various components of cable dock assembly 100 (FIG. 1) and/or cable dock assembly 900 (FIG. 9).

In some embodiments, cable dock assembly 1200 can include a first sub-assembly 1210 and/or a second sub-assembly 1240. Each of first sub-assembly 1210 and/or second sub-assembly 1240 can house circuitry, controller chips, plugs, and/or receptacles. In a number of embodiments, cable dock assembly 1200 can include a first electrical cable 1201. First electrical cable 1201 can include a first end 1202 and/or a second end 1203. First end 1202 can be attached at first sub-assembly 1210 and second end 1203 can be attached at second sub-assembly 1240. First electrical cable 1201 can be identical or substantially similar to first electrical cable 101 (FIG. 1).

In a number of embodiments, first sub-assembly 1210 can be similar to first sub-assembly 110 (FIG. 1) and/or first sub-assembly 910 (FIG. 9), and various components and/or constructions of first sub-assembly 1210 can be identical or substantially similar to various components of first sub-assembly 110 (FIG. 1) and/or first sub-assembly 910 (FIG. 9). For example, first sub-assembly 1210 can include a first housing 1211, a second housing 1212, a housing-to-housing electrical cable 1213, and/or a network receptacle 1214. First housing 1211 can be identical or substantially similar to first housing 111 (FIG. 1) and/or first housing 911 (FIG. 9), second housing 1212 can be identical or substantially similar to second housing 112 (FIG. 1) and/or second housing 912 (FIG. 9), housing-to-housing electrical cable 1213 can be identical or substantially similar to housing-to-housing electrical cable 113 (FIG. 1) and/or housing-to-housing electrical cable 913 (FIG. 9), and/or network receptacle 1214 can be identical or substantially similar to network receptacle 114 (FIG. 1) and/or network receptacle 114 (FIG. 1).

In many embodiments, second sub-assembly 1240 can be similar to second sub-assembly 140 (FIG. 1) and/or second sub-assembly 940 (FIG. 9), and various components and/or constructions of second sub-assembly 1240 can be identical or substantially similar to various components of second sub-assembly 140 (FIG. 1) and/or second sub-assembly 940 (FIG. 9). For example, second sub-assembly 1240 can include a first video display plug 1241 and/or a strain relief 1242. First video display plug 1241 can be configured to removably attach to a video display and can be identical or substantially similar to first video display plug 141 (FIG. 1) and/or first video display plug 941 (FIG. 9), and/or strain relief 1242 can be identical or substantially similar to strain relief 142 (FIG. 1) and/or strain relief 942 (FIG. 9). In various embodiments, cable dock assembly 1200 can include one or more first universal serial bus receptacles 1243. In some embodiments, first universal serial bus receptacles 1243 can be attached to second sub-assembly 1240 by one or more first pigtail cables 1244. In a number of embodiments, first universal serial bus receptacles 1243 can include connective elements 1245. First universal serial bus receptacles 1243 can be identical or substantially similar to first universal serial bus receptacles 143 (FIG. 1) and/or first universal serial bus receptacles 943 (FIG. 9), first pigtail cables 1244 can be identical or substantially similar to first pigtail cables 144 (FIG. 1) and/or first pigtail cables 944 (FIG. 9), and/or connective elements 1245 can be identical or substantially similar to connective elements 145 (FIG. 1) and/or connective elements 945 (FIG. 9).

In a number of embodiments, cable dock assembly 1200 can include one or more controller chips, which can facilitate operative connections between a computing device wirelessly coupled to cable dock assembly 1200 and various peripheral devices connected to one or more of network receptacle 1214, first video display plug 1241, and/or first universal serial bus receptacles 1243. In many embodiments, cable dock assembly 1200 can advantageously consolidate several peripheral inputs for connection to the computing device. In many embodiments, the controller chips can be fully contained within one or more of first sub-assembly 1210 and/or second sub-assembly 1240. For example, cable dock assembly 1200 can include a first universal serial bus hub controller (not shown), which can be identical or similar to first universal serial bus hub controller 220; a video controller (not shown), which can be identical or similar to video controller 1060; an Ethernet transceiver (not shown), which can be identical or similar to Ethernet transceiver 240; and/or a wireless controller (not shown). In many embodiments, the wireless controller be fully housed within first sub-assembly 1210. In certain embodiments, the wireless controller can be fully housed within first housing 1211. In certain other embodiments, the wireless controller can be fully housed within second housing 1212. In a number of embodiments, the wireless controller can be electrically coupled to an upstream port of the first universal serial bus hub controller. In many embodiments, the wireless controller can be configured to communicate with the computing device via the Institute of Electrical and Electronics Engineers (IEEE) 802.11ad wireless communication specification, also known as WiGig, or another suitable high-speed wireless communication protocol.

In various embodiments, cable dock assembly 1200 can be configured such that, when first sub-assembly 1210 is attached to a power source and second sub-assembly 1240 is attached to a first video display on a surface, first sub-assembly 1210 and second sub-assembly 1240 each do not touch the surface. The sub-assemblies (e.g., 1210, 1240) of cable dock assembly 1200 can have a zero footprint on the surface, which can advantageously allow for docking a computing device at a desk without electronic components cluttering the surface of the desk when the computing device is or is not wirelessly coupled to cable dock assembly 1200. In many embodiments, first sub-assembly 1210 and/or second sub-assembly 940 can each be no larger than 80 mm by 40 mm by 125 mm and/or can have a volume of less than or equal to 400 cm³.

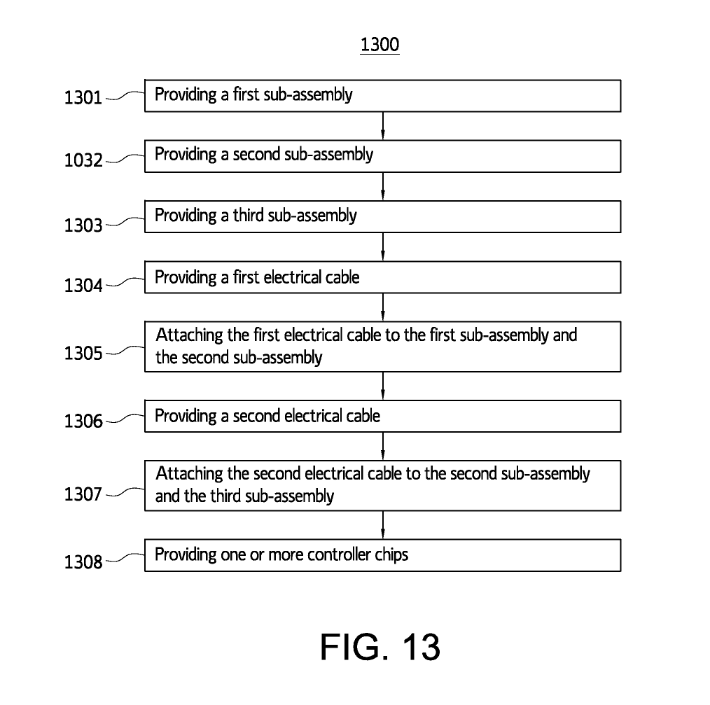

Turning ahead in the drawings, FIG. 13 illustrates a flow chart for an embodiment of method 1300 of manufacturing a cable dock assembly. Method 1300 is merely exemplary and is not limited to the embodiments presented herein. Method 1300 can be employed in many different embodiments or examples not specifically depicted or described herein. In some embodiments, the procedures, the processes, and/or the activities of method 1300 can be performed in the order presented. In other embodiments, the procedures, the processes, and/or the activities of the method 1300 can be performed in any other suitable order. In still other embodiments, one or more of the procedures, the processes, and/or the activities in method 1300 can be combined or skipped.

Referring to FIG. 13, method 1300 can include procedure 1301 of providing a first sub-assembly. In certain embodiments, the first sub-assembly can include a power adapter configured to removably attach to a power source. In other embodiments, the power adapter can be permanently attached to the power source. In many embodiments, the first sub-assembly can be similar or identical to first sub-assembly 110 (FIG. 1), first sub-assembly 910 (FIG. 9), and/or first sub-assembly 1210 (FIG. 12).

Method 1300 can continue with procedure 1302 of providing a second sub-assembly. In certain embodiments, the second sub-assembly can include a first video display plug configured to removably attach to a first video display. In other embodiments, the first video display plug can be permanently attached to a first video display. In some embodiments, the second sub-assembly can be similar or identical to second sub-assembly 140 (FIG. 1), second sub-assembly 940 (FIG. 9), and/or second sub-assembly 1240 (FIG. 12).

Method 1300 can continue with procedure 1303 of providing a third sub-assembly. In certain embodiments, the third sub-assembly can include a universal serial bus plug configured to removably attach to a computing device placed on a surface. In other embodiments, the universal serial bus plug can be permanently attached to the computing device. In some embodiments, the third sub-assembly can be similar or identical to third sub-assembly 170 (FIG. 1), third sub-assembly 970 (FIG. 9), and/or third sub-assembly 1270 (FIG. 12).

Method 1300 can continue with procedure 1304 of providing a first electrical cable. In certain embodiments, the first electrical cable can include a first end and a second end. In some embodiments, the first electrical cable can be similar or identical to first electrical cable 101 (FIG. 1), first electrical cable 901 (FIG. 9), and/or first electrical cable 1201 (FIG. 12).

Method 1300 can continue with procedure 1305 of attaching the first end of the first electrical cable to the first sub-assembly and the second end of the first electrical cable to the second sub-assembly. In certain embodiments, the first electrical cable can be removably attached to the first sub-assembly and/or the second sub-assembly. In other embodiments, the first electrical cable can be permanently attached to the first sub-assembly and/or the second sub-assembly.

Method 1300 can continue with procedure 1306 of providing a second electrical cable. In certain embodiments, the second electrical cable can include a first end and a second end. In some embodiments, the second electrical cable can be similar or identical to second electrical cable 105 (FIG. 1), second electrical cable 905 (FIG. 9), and/or second electrical cable 1205 (FIG. 12).

Method 1300 can continue with procedure 1307 of attaching the first end of the second electrical cable to the second sub-assembly and the second end of the second electrical cable to the third sub-assembly. In certain embodiments, the second electrical cable can be removably attached to the second sub-assembly and/or the third sub-assembly. In other embodiments, the second electrical cable can be permanently attached to the second sub-assembly and/or the third sub-assembly.

Method 1300 can continue with procedure 1308 of providing one or more controller chips. The controller chips can be similar or identical to first universal serial bus hub controller 220 (FIGS. 2-3, 10-11), video controller 230 (FIGS. 2-3), Ethernet transceiver 240 (FIGS. 2-3, 10-11), second universal serial bus hub controller 350 (FIGS. 3, 11), video controller 1060 (FIGS. 10-11), and/or display controller 1070 (FIGS. 10-11). In some embodiments, the controller chips can be fully contained within at least one of the first, second, or third sub-assemblies. In many embodiments, the first universal serial bus hub controller can be fully housed within the first sub-assembly. In a number of embodiments, the video controller can be fully housed within the first sub-assembly. In certain embodiments, the second universal serial bus hub controller can be fully housed within the second sub-assembly. In many embodiments, the cable dock assembly can be configured such that, when the first sub-assembly is attached to the power source, the second sub-assembly is attached to the video display, and the third sub-assembly is attached to the computing device, the first, second, and third sub-assemblies are each devoid of touching the surface.

Although the cable dock assembly has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-13 may be modified, and that the foregoing discussion of certain of these embodiments does not necessarily represent a complete description of all possible embodiments. For example, the USB ports, connectors, and/or protocols can be replaced with any other suitable communication ports, connectors and/or protocols, such as the Lightning ports, connectors, and/or protocols, developed by Apple, Inc. of Cupertino, Calif. As another example, one or more of the procedures, processes, or activities of FIG. 13 may be include different procedures, processes, and/or activities and be performed by many different modules, in many different orders.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A cable dock assembly comprising:
a first sub-assembly comprising a power adapter configured to removably or non-removably attach to a power source;
a second sub-assembly comprising a first video display plug configured to removably attach to a first video display;
a third sub-assembly comprising a universal serial bus plug configured to removably attach to a computing device placed on a surface;
a first electrical cable comprising a first end attached at the first sub-assembly and a second end attached at the second sub-assembly;
a second electrical cable comprising a first end attached at the second sub-assembly and a second end attached at the third sub-assembly; and
one or more controller chips,
wherein:
the one or more controller chips are fully contained within at least one of the first, second, or third sub-assemblies; and
the cable dock assembly is configured such that, when the first sub-assembly is attached to the power source, the second sub-assembly is attached to the video display, and the third sub-assembly is attached to the computing device, the first, second, and third sub-assemblies are each devoid of touching the surface.

2. The cable dock assembly of claim 1 comprising:
one or more first universal serial bus receptacles;
one or more first pigtail cables each connecting a different one of the one or more first universal serial bus receptacles to the second sub-assembly.

3. The cable dock assembly of claim 2 comprising:
one or more second universal serial bus receptacles;
one or more second pigtail cables each connecting a different one of the second universal serial bus receptacles to the third sub-assembly.

4. The cable dock assembly of claim 3 comprising:
an audio receptacle;
a third pigtail cable connecting the audio receptacle to the third sub-assembly.

5. The cable dock assembly of claim 1, wherein:
the one or more controller chips comprise a first universal serial bus hub controller housed within the first sub-assembly.

6. The cable dock assembly of claim 1, wherein:
the one or more controller chips comprise a video controller housed within the first sub-assembly.

7. The cable dock assembly of claim 1, wherein:
the first sub-assembly comprises a network receptacle.

8. The cable dock assembly of claim 1, wherein:
the one or more controller chips comprises a second universal serial bus hub controller housed within the second sub-assembly.

9. The cable dock assembly of claim 1, wherein:
the one or more controller chips comprises:
a first universal serial bus hub controller;
a second universal serial bus hub controller; and
a video controller; and
the first sub-assembly comprises:
a first housing comprising the power adapter and the first universal serial bus hub controller;
a second housing comprising the video controller; and
a housing-to-housing electrical cable connecting the first housing to the second housing.

10. The cable dock assembly of claim 1, wherein:
the one or more controller chips comprises:
a first universal serial bus hub controller;
a second universal serial bus hub controller; and
a video controller; and
the first sub-assembly comprises a unitary housing containing the power adapter, the first universal serial bus hub controller, and the video controller.

11. The cable dock assembly of claim 1, wherein:
the first, second, and third sub-assemblies each have a volume of less than or equal to 400 cm³.

12. The cable dock assembly of claim 1 comprising:
a fourth sub-assembly comprising a second video display plug configured to removably attach to a second video display; and
a third electrical cable comprising a first end attached at the first sub-assembly and a second end attached at the fourth sub-assembly.

13. The cable dock assembly of claim 1 comprising:
one or more first universal serial bus receptacles;
one or more second universal serial bus receptacles;
an audio receptacle, and
a network receptacle;
wherein:
the one or more controller chips comprises a first universal serial bus hub controller and a video controller;
the first universal serial bus hub controller is electrically coupled to the universal serial bus plug, the one or more first universal serial bus receptacles, the one or more second universal serial bus receptacles, and the video controller; and
the video controller is electrically coupled to the first video display plug, the audio receptacle, and the network receptacle.

14. The cable dock assembly of claim 1 comprising:
one or more first universal serial bus receptacles;
one or more second universal serial bus receptacles;
an audio receptacle, and
a network receptacle;
wherein:
the one or more controller chips comprises a first universal serial bus hub controller, a video controller, and a second universal serial bus hub controller;
the first universal serial bus hub controller is electrically coupled to the universal serial bus plug, the one or more second universal serial bus receptacles, the second universal serial bus hub controller, and the video controller;
the video controller is electrically coupled to the first video display plug, the audio receptacle, and the network receptacle; and
the second universal serial bus hub controller is electrically coupled to the one or more first universal serial bus hub receptacles.

15. The cable dock assembly of claim 1 comprising:
a fourth sub-assembly comprising a second video display plug configured to removably attach to a second video display;
a third electrical cable comprising a first end attached at the first sub-assembly and a second end attached at the fourth sub-assembly;
one or more first universal serial bus receptacles;
one or more second universal serial bus receptacles;
an audio receptacle, and
a network receptacle;
wherein:
the one or more controller chips comprises a first universal serial bus hub controller and a video controller;
the first universal serial bus hub controller is electrically coupled to the universal serial bus plug, the one or more first universal serial bus receptacles, the one or more second universal serial bus receptacles, and the video controller; and
the video controller is electrically coupled to the first video display plug, the second video display plug, the audio receptacle, and the network receptacle.

16. The cable dock assembly of claim 1 comprising:
a fourth sub-assembly comprising a second video display plug configured to removably attach to a second video display;
a third electrical cable comprising a first end attached at the first sub-assembly and a second end attached at the fourth sub-assembly;
one or more first universal serial bus receptacles;
one or more second universal serial bus receptacles;
an audio receptacle, and
a network receptacle;
wherein:
the one or more controller chips comprises a first universal serial bus hub controller, a video controller, and a second universal serial bus hub controller;
the first universal serial bus hub controller is electrically coupled to the universal serial bus plug, the one or more second universal serial bus receptacles, the second universal serial bus hub controller, and the video controller;
the video controller is electrically coupled to the first video display plug, the second video display plug, the audio receptacle, and the network receptacle; and
the second universal serial bus hub controller is electrically coupled to the one or more first universal serial bus hub receptacles.

17. The cable dock assembly of claim 1, wherein:
the cable dock assembly comprises the computing device.

18. A method of manufacturing a cable dock assembly comprising:
providing a first sub-assembly comprising a power adapter configured to removably or non-removably attach to a power source;
providing a second sub-assembly comprising a first video display plug configured to removably attach to a first video display;
providing a third sub-assembly comprising a universal serial bus plug configured to removably attach to a computing device placed on a surface;
providing a first electrical cable comprising a first end and a second end;
attaching the first end of the first electrical cable to the first sub-assembly and the second end of the first electrical cable to the second sub-assembly;
providing a second electrical cable comprising a first end and a second end;
attaching the first end of the second electrical cable to the second sub-assembly and the second end of the second electrical cable to the third sub-assembly; and
providing one or more controller chips, wherein the one or more controller chips are fully contained within at least one of the first, second, or third sub-assemblies,
wherein
the cable dock assembly is configured such that, when the first sub-assembly is attached to the power source, the second sub-assembly is attached to the video display, and the third sub-assembly is attached to the computing device, the first, second, and third sub-assemblies are each devoid of touching the surface.

19. The method of claim 18 comprising:
providing one or more first universal serial bus receptacles;
providing one or more first pigtail cables;
connecting each of the one or more first pigtail cables between the second sub-assembly and a different one of the one or more first universal serial bus receptacles;
providing one or more second universal serial bus receptacles;
providing one or more second pigtail cables;
connecting each of the one or more second pigtail cables between the third sub-assembly and a different one of the one or more second universal serial bus receptacles;
providing an audio receptacle;
providing a third pigtail cable; and
connecting the third pigtail cable between the third sub-assembly and the audio receptacle.

20. The method of claim 18, wherein:
providing the one or more controller chips comprises:
providing a first universal serial bus hub controller fully housed within the first sub-assembly;
providing a video controller fully housed within the first sub-assembly; and
providing a second universal serial bus hub controller fully housed within the second sub-assembly.

21. The method of claim 18 comprising:
providing a fourth sub-assembly comprising a second video display plug configured to removably attach to a second video display;
providing a third electrical cable comprising a first end and a second end; and
attaching the first end of the third electrical cable to the first sub-assembly and the second end of the third electrical cable to the fourth sub-assembly.
